(19) United States
(12) Patent Application Publication
(10) Pub. No.: US 2013/0314208 A1
(43) Pub. Date: Nov. 28, 2013

(54) Systems And Methods For Storing And Accessing Confidential Data

(71) Applicant: Arkami, Inc, (US)

(72) Inventors: Tareq Adel Risheq, Laguna Niguel, CA (US); Dave Rand, Aliso Viejo, CA (US); Bill Lindsey, Aliso Viejo, CA (US); Benjamin Chen, Aliso Viejo, CA (US)

(73) Assignee: Arkami, Inc., Aliso Viejo, CA (US)

(21) Appl. No.: 13/890,201

(22) Filed: May 8, 2013

Related U.S. Application Data
(60) Provisional application No. 61/644,315, filed on May 8, 2012.
(60) Provisional application No. 61/647,719, filed on May 16, 2012.
(60) Provisional application No. 61/656,636, filed on Jun. 7, 2012.
(60) Provisional application No. 61/693,524, filed on Aug. 27, 2012.
(60) Provisional application No. 61/709,938, filed on Oct. 4, 2012.

(51) Int. Cl. G07C 9/00

(52) U.S. Cl. CPC G07C 9/00158
USPC 340/5.53

(57) ABSTRACT

Systems and methods for storing, managing, and accessing confidential data are described. In one aspect of the inventive subject matter, an authentication protocol includes the steps of capturing a user's biometric data, creating a plurality of templates from the biometric data, transforming a set of authentication data using the template, and determining an authentication status of the user based on the transformed authentication data.

This application claims the benefit of priority to U.S. Provisional Application Ser. No. 61/644,315, filed on May 8, 2012, U.S. Provisional Application Ser. No. 61/647,719, filed on May 16, 2012, U.S. Provisional Application Ser. No. 61/656,636, filed on Jun. 7, 2012, U.S. Provisional Application Ser. No. 61/693,524, filed on Aug. 27, 2012, and U.S. Provisional Application Ser. No. 61/709,938, filed on Oct. 4, 2012. These and all other referenced extrinsic materials are incorporated herein by reference in their entirety. Where a definition or use of a term in a reference that is incorporated by reference is inconsistent or contrary to the definition of that term provided herein, the definition of that term provided herein is deemed to be controlling.

### FIELD OF THE INVENTION

The field of the invention is secured electronic storage methods and devices.

### BACKGROUND

The following description includes information that may be useful in understanding the present invention. It is not an admission that any of the information provided herein is prior art or relevant to the presently claimed invention, or that any publication specifically or implicitly referenced is prior art.

The increased presence of the internet and electronic devices in our lives has created a situation in which we must remember and manage countless sets of passwords, user names, account numbers, and other confidential information in order to perform everyday tasks. The situation is further exasperated by the fact that each device (e.g., work desktop computer, work laptop, home desktop, home laptop, work smart phone, personal smart phone, etc.) and each content provider (e.g., internet web page) may have different password requirements/rules, preventing the user from using the same passwords (or usernames, account numbers, etc.) for every device and content provider.

Some have addressed this situation by providing smart phone applications that allow a user to store and manage confidential information. While useful in some limited aspects, this particular solution has several major drawbacks. First, smart phones usually require a password itself, in order to securely store the confidentially information. As a result, the user must remember at least one password in order to access the remaining passwords. Second, smart phones are usually large and expensive since the device must perform many other functions (e.g., web browsing, cellular phone calls, etc). Third, the device itself provides a way to, not only view the confidential data, but change/modify the data. As a result, if the smart phone security is compromised (e.g., the phone is stolen and the password to access the phone is cracked), an intruder can not only use the confidential information to harm the smart phone owner, but can also delete and/or modify the confidential data. In addition, a device that allows for viewing and modifying confidential data presents a risk that the user may accidentally delete or modify confidential information when attempting to merely view the data. Fourth, smart phones usually require multiple actions/steps in order to access the data (e.g., turn on phone, enter password, open application, find a description/title of the password or confidential information that is desired, select the description,). For someone who accesses confidential data multiple times during short periods of time, this process can be tedious and frustrating.

Others have provided mobile devices with biometric data recognition for storing confidential data in a secured manner. U.S. Pat. No. 8,126,506 to Roundtree, for example, describes a mobile device for storing confidential information in a secure manner using a biometric reader (e.g., a fingerprint reader). The article entitled “Fuzzy Vault for Fingerprints” by Uludag et al. discloses a fuzzy vault for authenticating users based on biometric information. U.S. Pat. No. 7,017,182 to Kiyomoto discloses encrypting data with fingerprint information. U.S. Patent Publication No. 2005/0055560 to Kendon discloses a method of securely storing and accessing personal data on a portable device, where the key to decrypt the data is not stored on the portable device. However, these devices do not address all the problems associated with biometric readers. For example, many biometric readers are prone to error and can give false positives. In addition, many biometric readers store the user's biometric data on the device. As such, if the device is ever comprised, the intruder has access to the user's biometric data.

These and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

It would be advantageous to provide a device that addresses the problems above.

Thus, there is still a need for improved methods and devices for electronically storing and accessing confidential information in a secure manner.

### SUMMARY OF THE INVENTION

The inventive subject matter provides apparatus, systems and methods in which a portable storage device can be used to electronically store confidential data and/or act as a key to access information stored on another device. The device includes some or all of the following: a processor, an electronic storage medium (e.g., hard drive, flash drive, etc), a set of executable code (e.g., software code, script, etc), a display, a memory card slot, a memory card, and a biometric data sensor. In some aspects of the inventive subject matter, the device can comprise a mobile phone. The electronic storage medium is configured to store a plurality of confidential data objects and/or biometric data. The display can be used to display the confidential data objects to a user. The biometric data sensor can be used to provide access to the confidential data objects until a valid/authorized biometric data is presented. The biometric data sensor can also be used to provide access to a computer or other device generally (e.g., a user could be prevented from accessing a laptop computer, a desktop computer, an electronic reader, a mobile phone, or other device associated with a portable storage device, until a valid/authorized biometric data is presented to the biometric data sensor of the portable storage device). In this way, the portable storage device could act as a key to a device.

As used herein, “biometric data” means any characteristic suitable for uniquely identifying a user. Biometric authentication is well known and generally relies on physiological and behavioral characteristics. However, other characteristics could also be used consistently with the inventive subject matter. Contemplated biometric data include, but is not limited to, fingerprints, iris, voice pattern, facial features, and a handwritten signature. In some embodiments, the portable device could be integrated with a glucose meter and use blood samples to provide authentication.

In some aspects of the inventive subject matter, a user can set a password that is configured to provide a second layer of protection to a user's confidential data or device. For example, a user can input a tap sequence onto a touch-screen of a device (e.g., two taps on a left side of the screen and three taps on a right side of the screen), a tap sequence onto physical buttons of a device (e.g., press an up button three times and a down button 6 times), or set an alphanumeric password to unlock a device. Then this tap sequence or other password can be required in addition to biometric authentication before a user can access confidential data or a device. Alternatively, the tap sequence could be used in lieu of the biometric data sensor to access the confidential data.

In another aspect of some embodiments, the portable device also has one or more buttons for scrolling through the confidential data objects in any suitable direction (e.g., up, down, left, right, etc.). Other scrolling devices could include a touch screen display, a voice command sensor, or a wheel. It is also contemplated that buttons and touch screens can be used to input a personal identification number (PIN) or other password.

Contemplated portable devices can include password management software configured to generate and store a password, PIN or other alphanumerical sequence, which can be used to access a third party website such as a bank website, social networking website, or a “members only” website. This generation can be automatic at set intervals (e.g., once a week, once a month, etc.) or manual. For example, a user can configure a device to automatically reset 1, 5, 10, 100, or even 1,000 or more passwords at a set time (e.g., once a week), and these passwords can be automatically stored for access by a user who has been authenticated. Such automatic generation of batches of passwords can allow a user to change several passwords simultaneously without having to manually reset/change each password individually. In other aspects, the software allows the user to define password change policies (e.g., at least one letter and number, at least 8 digits long, etc.) for each password to ensure that the automatically generated passwords comply with third party password policies.

The automatic generation of passwords can be separated into various batches based on password change policies, the importance of protecting a password, or any other suitable basis. Thus, a user can create a batch job of all passwords corresponding to a website that requires any password change to comprise 6-8 characters, at least one of which is a capital letter. A user can create a second batch job of all passwords corresponding to low importance passwords, such as those corresponding to gym membership login pages and other websites where very little personal information is made available to a viewer. 1, 10, 25, or even 100 or more batch jobs can be created and saved to automatically generate or change passwords at recurring intervals.

Contemplated portable devices can include contact information management software configured to update contact information associated with a third party server. A contact information update can also be performed in batches as described above. This software can allow a user to notify two or more third party servers that the user's address, phone number, email address or other personal data has changed, without the user having to go to each individual website to update contact information.

Each of the password management software and the contact information management software could be stored locally on the portable device, on a physically accessible computer (e.g., personal laptop, home desktop computer, work computer, work server) or could be stored remotely on a cloud server (e.g., a computer or server that is accessible via a wide area connection such as the internet). In some embodiments, software can be configured to interact with third party servers (e.g., online banking website, PayPal® accounts, email accounts, eBay® account, etc) to update contact information or passwords automatically.

From a methods perspective, a user can update a batch of passwords by: (i) plugging the portable device into a local computer; (ii) using the computer to access a login page to the password management software (which can be stored on a cloud server) via a web portal and an internet connection; (iii) supplying biometric data to the cloud server in a secure manner via the portable device, local computer, and internet connection to authenticate login credentials; (iv) instructing the password management software to generate an updated batch of passwords based on predefined password policies; and (v) instructing the password management software to update third party passwords using the newly updated batch of passwords.

The updated batch of passwords can be stored on the cloud server, portable device, and/or local computer. The updated third party passwords are stored on third party storage devices (e.g., a server that hosts an online banking website). A user can update contact information on a batch of third party websites by (i) plugging the portable device into a local computer, (ii) using the computer to access a login page to the contact information management software (which can be stored on a cloud server) via a web portal and an internet connection; (iii) supplying biometric data to the cloud server to authenticate login credentials; and (iv) instructing the contact information management software to update contact information on a batch of third party websites.

Numerous methods of securely sending authentication data over the internet are known and can include encryption protocols such as public-key encryption.

In an alternative method, the portable device can be a smart device (e.g., has a display, internet connectivity, input means, etc) and has the password management software or contact information management software stored therein. As a result, the portable device can communicate directly with the cloud server, eliminating the need for steps (i) and (ii). For example, a device can be configured such that a user can update batches of contact information or passwords via a single touch of a button on the device, entering a code onto a touch-screen of the device, or via voice command. In other aspects of the inventive subject matter, the steps (iv) and (v) of using the password management software can be combined by allowing the user to provide one instruction that initiates both the generation of an updated batch of passwords and the updating of third party passwords.

In other aspects, one or both of the contact information management software and the password management software can include a “passcard” feature. In yet another aspect of the inventive subject matter, a connection between a portable storage device and a cloud server or other server can be secured via a passcard feature. Passcard data can include biometric data, pre-stored data, a password, PIN or other alphanumeric code, or any combination thereof. The passcard can comprise two separate data sets: the first data set being stored on the portable device and the second data set being stored on an external device (e.g., cloud server, home computer, laptop, etc.). When the two data sets are paired (e.g., by communicatively coupling the portable device and the external device) the passcard becomes active. The active passcard can then be used to provide authentication, either to access confidential data stored on the external device or on a third party device.

As used herein, “third party” refers to parties other than the entity that hosts, manages, controls, or distributes the password management software.

The passcard data set stored on the portable device can be stored in the by the seller (or the entity managing/hosting the cloud server and password management software) prior to a sale. The passcard data set stored on the portable device could alternatively be generated after the sale of the device to a user based on user biometric data. The passcard data set stored on the portable device could be a combination of user biometric data and pre-sale data provided by the seller.

In some embodiments, the portable device is configured to communicate with the cloud server using a proprietary communication protocol (e.g., a unique handshake). In such embodiments, it is contemplated that a host of a cloud server can place unique data on a portable device specially designed to interact with the hosted cloud server.

Confidential data can be stored on any suitable medium, including an electronic storage medium in the portable device, a cloud server, a computer, or any combination thereof. Each storage medium could be configured to communicatively couple to a second, third, or even fourth storage medium on a separate external device (e.g., a portable storage device, a laptop, smart phone, personal computer, cloud service accessible via a web browser, etc.). The communication between two or more confidential data storing mediums can be secured in any known way.

As used herein, the term “communicatively couple” can mean a wired connection (e.g., via a USB port) or a wireless connection (e.g., via a Wi-Fi network, Bluetooth, cellular network, cloud computing, etc.).

As used herein, “confidential data” refers to data that a user considers private. Examples of confidential data include, but are not limited to, passwords, user names, bank account numbers, service account numbers, passport numbers, social security numbers, credit card numbers, and titles or brief descriptions that identify confidential data (e.g., “gmail account login password,” “ebay account password,” “chase bank account routing number,” etc). The storage medium could also store meta data objects associated with the confidential data objects, such as date created, date modified, time created/modified, and a user that created the object. One of ordinary skill in the art will appreciate that the inventive subject matter can be applied to all kinds of data, regardless of whether the data is categorized as “confidential” by a user.

The storage medium could comprise a built-in memory and/or a memory stick or memory card that can be inserted into a slot of the portable storage device.

It is contemplated that various functions related to a portable storage device and/or a device coupled with the portable storage device, including for example, scrolling, adding text, deleting text, modifying text, powering on and off, changing a font, changing a size of a text, accessing a confidential data object, modifying a confidential data object, accessing a website, accessing a cloud server, or accessing an account, could be initiated via a keyboard input, a voice command input, or a touch-screen input. A keyboard input could be received by a device via a keyboard that composes the device. A voice command input could be received by a device via a voice command sensor that composes the device. A touch-screen input (including touch-screen text input) could be received by a device via a user display that composes the device. Each of a keyboard, a voice command sensor, and a user display is a user interface.

From a methods perspective, one aspect of the inventive subject matter provides a simple and quick way to view confidential data by presenting a biometric data to the biometric data sensor of the portable device described above. Once an authorized biometric data and/or biometric data object is recognized/detected, the device automatically displays the user data without the need for further human action. For example, it is not necessary that the user turn on the display or select an application within the display or plow through folder hierarchies.

Another aspect of the inventive subject matter provides a simple and quick way to unlock confidential data stored on a cloud or a physically separate device. For example, the portable device could act as one of the keys or the only key to a cloud, such that when a pre-determined biometric data object is received by a biometric data sensor, the device unlocks (e.g., passes authentication) a cloud so that confidential data stored within the cloud can be presented to a user. Where the device is the only key to the cloud, a user will not be able to access the confidential data stored within the cloud without authentication via the device.

It is contemplated that the presentation of confidential data stored within a physically separate device could either be on the display screen of the unlocking device or on another computing device to which the unlocking device is communicatively coupled. Where the presentation is on the display screen of the unlocking device (key), it is contemplated that the display screen could display text. Such text could prompt the user to provide a fingerprint to the biometric data sensor or ask the user if he or she would like to access confidential data stored on the unlocking device, a second device, a third device, and/or other suitable device.

Where the presentation of data is on another computing device, such as a personal computer, tablet computer, smart phone, or other suitable computing device, it is contemplated that the unlocking device could act as one of the keys or the only key to allowing the computing device to display confidential data that is stored on the computing device and/or the unlocking device.

In other aspects of the inventive subject matter, the portable device could be required in order to unlock a display screen of another device, and/or to power on a device. For example, a desktop or laptop computer could require that (1) the portable device be inserted into a port coupled to the hard drive, and/or (2) a fingerprint or other biometric data object be received by the biometric sensor of the portable device, in order to (i) present the user with screen items such as icons, folders, shortcuts, task bars, or any other displayed information, and/or (ii) to power on the device comprising the port.

It is also contemplated that the portable storage device could be used on 1, 2, 5, 10, or even all devices comprising a port configured to accept the portable storage device (e.g., a single portable storage device could be used on any desktop or laptop computer to access information stored within the portable storage device and/or computer).

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1 is a top view of one embodiment of a portable authentication device with a biometric sensor for accessing confidential data.

FIG. 2 is a top view of another embodiment of a portable authentication device for accessing confidential data.

FIG. 3a is a schematic of a portable device in communication with an external device.

FIG. 3b is a schematic of a portable device in communication with two external devices.

FIG. 4 is a perspective view of another embodiment of a portable authentication device for accessing confidential data.

FIG. 5 is a perspective view of another embodiment of a portable authentication device for accessing confidential data.

FIGS. 6A-6D show additional embodiments of a portable authentication device for accessing confidential data.

FIGS. 7A-7C show additional embodiments of a portable authentication device for accessing confidential data.

FIGS. 8A-8C show additional embodiments of a portable authentication device for accessing confidential data.

FIGS. 9A-9C show additional embodiments of a portable authentication device for accessing confidential data.

FIGS. 10A-10D show additional embodiments of a portable authentication device for accessing confidential data.

FIGS. 11A-11E show additional embodiments of a portable authentication device for accessing confidential data.

FIGS. 12A-12D show additional embodiments of a portable authentication device for accessing confidential data.

FIGS. 13A-13D show additional embodiments of a portable authentication device for accessing confidential data.

FIG. 14 shows one embodiment of a portable authentication device for accessing confidential data having a touch screen, scroll buttons, memory card slot, and a USB cap.

FIG. 15 is a schematic of a portable authentication device communicatively coupled with multiple external devices via the internet.

FIG. 16 is a schematic of a portable authentication device communicatively coupled with multiple external devices.

FIG. 17 is a schematic of a management server for managing authentication of a portable authentication device and for managing confidential data.

FIG. 18 is a schematic of one embodiment of an authentication.

FIG. 19 is a schematic of one embodiment of an authentication protocol.

FIG. 20 is a schematic of a method of encrypting a seed using a template derived from a biometric.

### DETAILED DESCRIPTION

Throughout the following discussion, numerous references will be made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions. One should appreciate that the present inventive subject matter provides numerous technical effects, including providing devices and methods for efficiently accessing confidential data that is stored in a secured environment.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

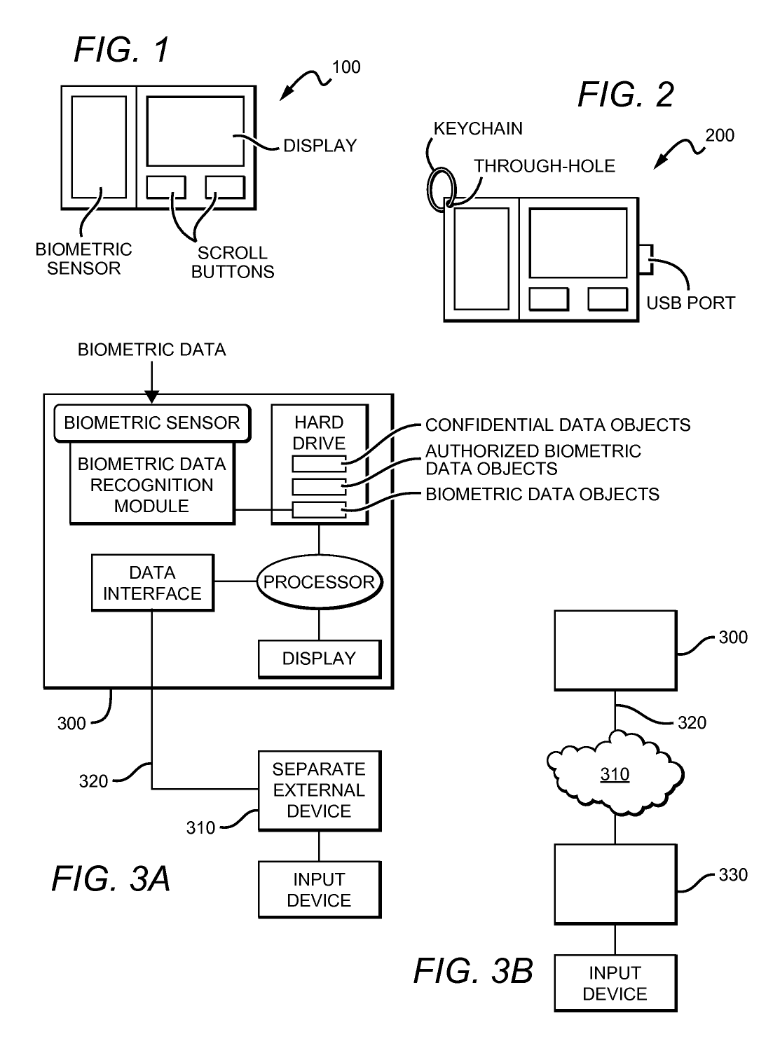

FIG. 1 shows a perspective view of a portable device 100. Device 100 has a display, a biometric data sensor/reader, and two scroll buttons. Inside device 100 is a processor, electronic storage medium, and executable instructions. The executable instructions have a biometric data recognition module. When a user presents a biometric data to the biometric data reader/sensor, the recognition module analyzes the biometric data to determine if it is an authorized biometric data. If the biometric data is an authorized biometric data, then the display will automatically show confidential data stored on the electronic storage medium, without the need for further human action.

The housing of device 100 can be made out of metal, plastic, composite, or any other material suitable for storing the necessary components. In some embodiments, device 100 has a water resistant housing.

Device 100 can be any size suitable for housing the necessary components. In some embodiments, device 100 is no bigger than about twice the size of an average adult thumb. Processors, storage devices, displays, biometric data sensors, and biometric data recognition technologies are well known. See for example, U.S. Pat. No. 8,126,506, U.S. Pat. No. 6,748,541, JP2007115103, US20050210270, US20080194296, WO2008101135, CN102270284, US20030174256, US20050249386, US20090046904, WO0248485, WO2012053875, WO2012054357, which are incorporated herein by reference. Device 100 can comprise any variation or configuration of electrical components that are capable of performing the functions described herein. The present inventive subject matter is not intended to be limited by any particular technology or embodiment of such components. In some embodiments, the storage medium and processor are made such that they perform no additional function other than to (1) store confidential information, (2) display confidential information, and (3) control viewing access as a function of a biometric data. In this manner, the cost and size of device 100 is greatly minimized. Embodiments with minimal computing/processing and executable code (software applications) relative to the current state of the art will be referred to as “dumb devices.”

Dumb devices are much cheaper and smaller than smart devices, and can provide several advantages over smart devices. First, if a dumb device is lost, the user is not left without other important functions (e.g., cell phone capabilities, email access, internet browsing, text communication, media content access, etc). Second, multiple dumb devices can be purchased for the same price as a smart device. In some embodiments where the device is a dumb device, it is contemplated that a user can plug the dumb device into a computing device (e.g., a computer, a laptop, a tablet computer, etc.) to access a cloud server that is communicatively coupled to one or more third party servers. Thus, a user could plug the device into a computer, the computer could connect to a cloud server, and the user can automatically be logged into one or more third party server websites. For example, a user could have a dumb device that is communicatively coupled to a cloud server storing login information for Wells Fargo™, Bank of America™, and Facebook™. When the user plugs in the dumb device to a local computer and provides biometric data, the local computer could then contact the cloud server hosting the management software, which, upon authentication, automatically signs the user onto the three websites by providing the three websites with the appropriate authentication credentials. At that point, the user can be presented with three open webpages that are already logged in at the local computer display, without clicking a single button. In another aspect of the inventive subject matter, a user can be presented with a webpage that the user is logged into only upon an additional input (e.g., clicking open a web browser, entering a web address, etc.). In yet another aspect of the inventive subject matter, a user can be automatically logged off of the websites when the dumb device is unplugged from the computer.

It is contemplated that a user could purchase and use multiple portable devices 100 to store the same confidential data, or overlapping subsets of confidential data. Using multiple devices provides backup of the confidential data and accessible at different locations. For example, a user can use a portable device for work and leave the device at a work setting. Another device can be stored and used from the user's car. A third device can be stored and used from the user's home. In this manner, the user can access the confidential data from multiple locations without having to carry the confidential data on his or her person at all times. Third, the smaller size of a dumb device allows device 100 to be hidden more easily to prevent theft.

FIG. 2 shows a perspective view of a portable device 200. Device 200 is similar to device 100 except that device 100 has a through-hole, keychain, and a USB port. The keychain can be used to couple keys to device 200. The USB port allows device 200 to exchange data with an external device, such as a laptop or personal computer. Data interfaces other than USB ports can also be used, depending on the current technology. Moreover, the data interface could comprise a wireless connection with the external device, for example, via a wireless transceiver using a wireless protocol.

FIG. 3A shows a schematic of a portable device 300 and an external device 310 communicatively coupled via connection 320. Connection 320 can be wired or wireless and a local area connection or a wide area connection (including the World Wide Web). Device 300 has a hard drive connected to a processor. The hard drive stores a plurality of confidential data objects, authorized biometric data objects, and biometric data objects. The confidential data objects represent confidential information, such as bank account numbers, passwords, user names, etc. The authorized biometric data objects represent characteristics of a biometric data that is authorized to access the confidential data objects. The biometric data objects represent the biometric data (e.g., an actual fingerprint or iris) that is presented at the biometric data sensor and describes characteristics of the biometric data. (In other embodiments, the biometric data objects are not permanently stored on the hard drive; rather the objects are temporarily stored for recognition analysis and then automatically or manually discarded). The hard drive has a biometric data recognition module (e.g., executable instructions, software code, script, etc) that compares the biometric data objects to the authorized biometric data objects to determine if there is a match. If a match is detected, a display module (not shown) or the biometric data recognition module, automatically displays at least a subset of the confidential data objects on the display to a user.

Device 300 also has a data interface for communicating with external device 310. Device 310 has an input device (e.g., voice recognition, mouse, keyboard, touch screen, etc) that allows a user to add, delete, or modify confidential data objects on the hard drive of device 300. External device 310 preferably has its own processor, hard drive, and executable instructions (not shown) that allow a user to add/delete/modify confidential data objects on the hard drive of device 300. Device 310 could also be capable of adding/deleting/modifying authorized biometric data objects to establish new users via a new authorized biometric data. Device 310 could also include modules for associating user rights with different users to limit access to the confidential data objects.

It is further contemplated that there could be a third device 330 configured to couple with the Device 300, external device 310, or both, as shown in FIG. 3B. Where external storage device 310 is a cloud service, it is contemplated that this third device 330 could also or alternatively have an input device that allows a user to add/delete/modify authorized biometric data objects to establish new users via a new authorized biometric data. Portable device 300 preferably backs up data automatically to external device 310 and/or external device 330. In some embodiments, portable device 300 uses a smart phone's cellular communication network to backup data to a cloud service via the cellular network. Portable device 300 could connect to the smart phone via a wireless connection (e.g., Bluetooth) or via a wired connection (e.g., via the smart phone's proprietary data port). In other embodiments, portable device 300 has electrical components for wirelessly connecting to a cloud service without the need for another device (e.g., without having to connect through a smart phone, laptop, or desktop computer).

As shown in FIG. 3A, device 300 is not capable of receiving inputs to modify/add/delete confidential data objects on its own. Rather, it must connect with an external device or third device to provide such functionality to a user. In alternative embodiments device 300 can be adapted to include an input device for allowing a user to add/delete/modify data on the hard drive without having to connect to an external device. However, preventing a user from directly accessing the hard drive of device 300 prevents a user from accidentally changing data while viewing the data on a daily basis (without connecting to an external hard drive) and also reduces the costs and size of device 300.

It is contemplated that a portable storage device could be configured to automatically input confidential data (e.g., a username and/or password) onto a website, etc. For example, a portable storage device could be configured such that when it is coupled to an external device accessing a banking account login website, the portable storage device could automatically enter login information (confidential data) stored therein.

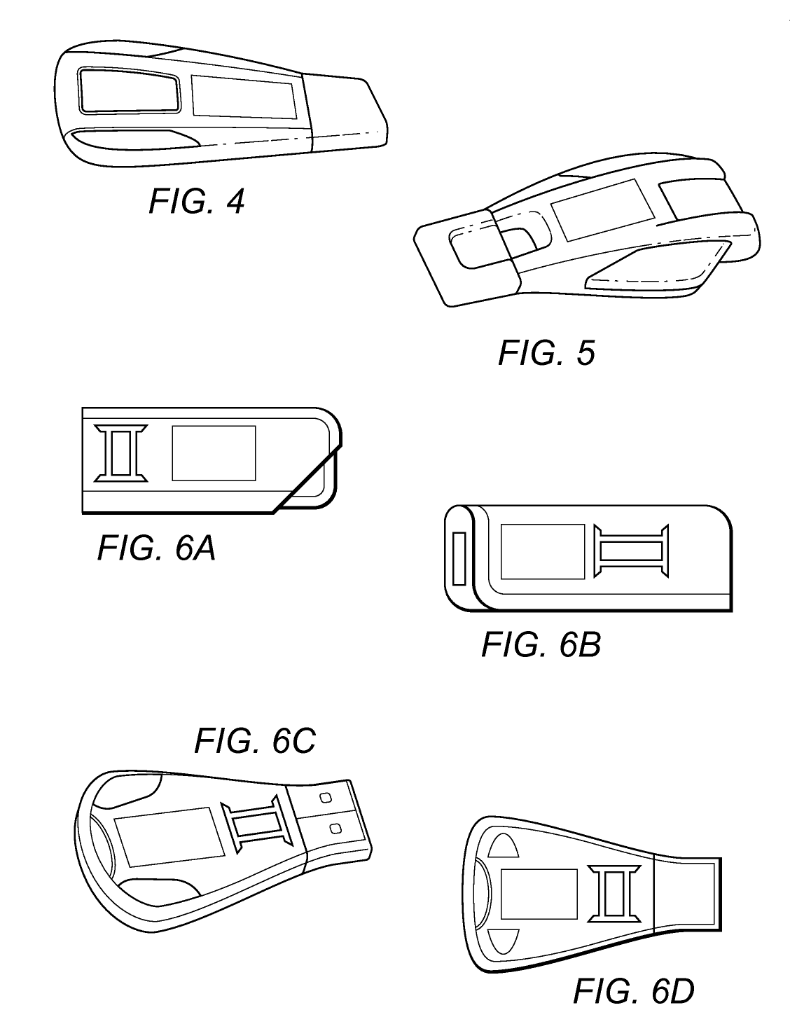

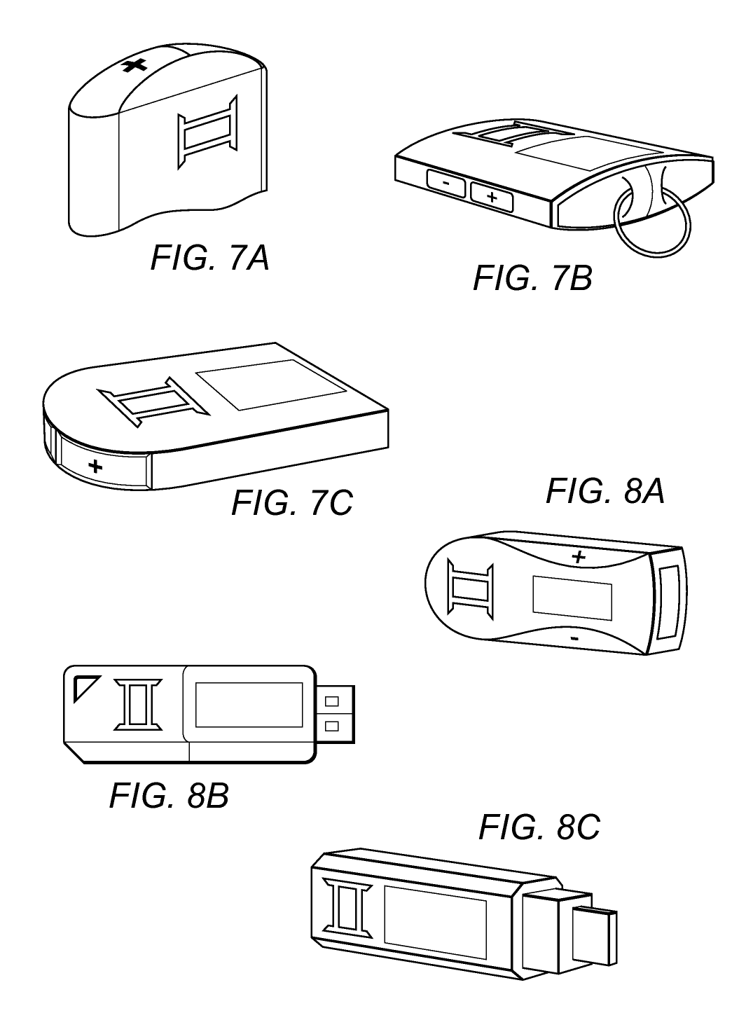

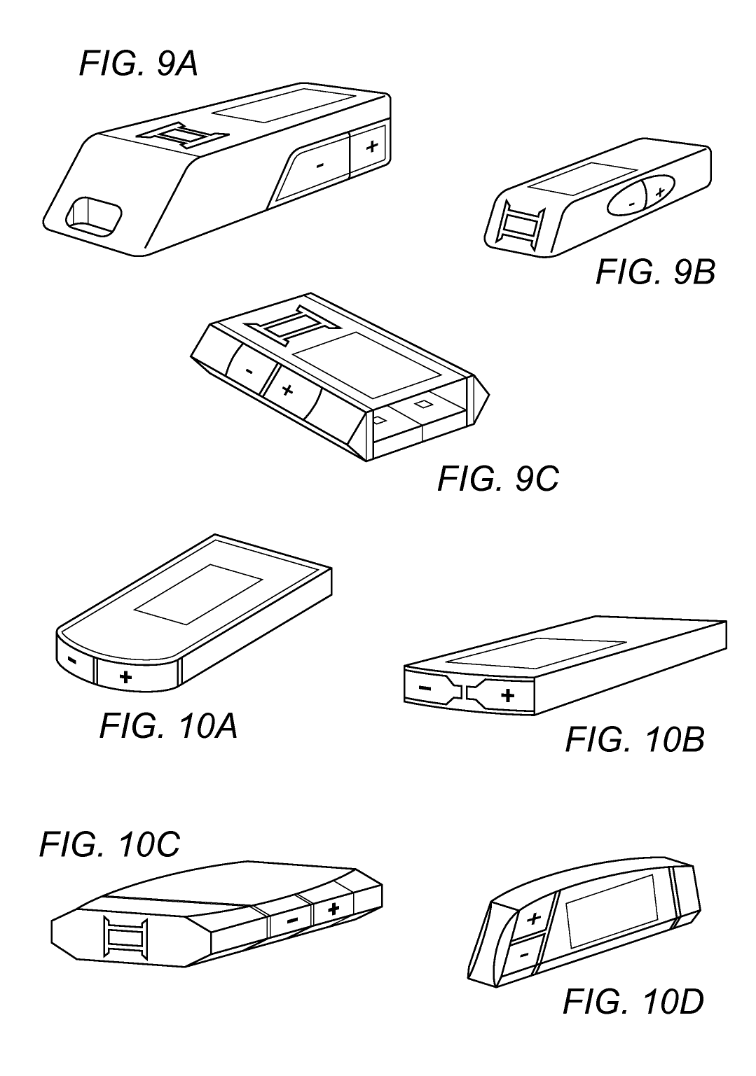

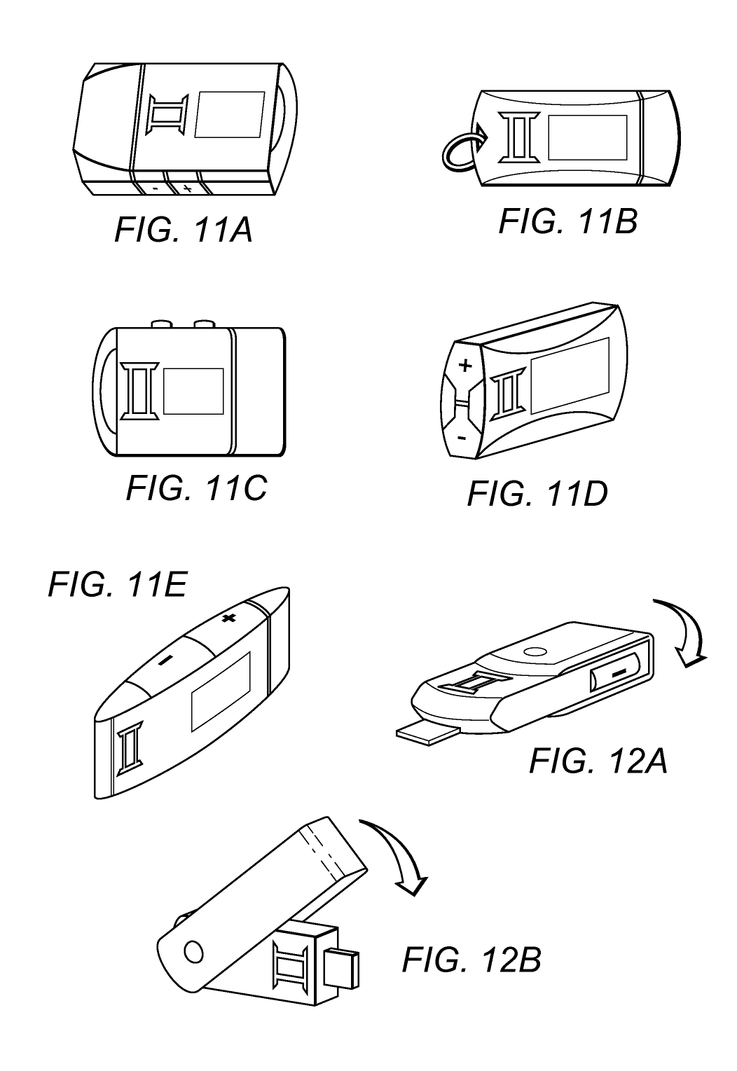

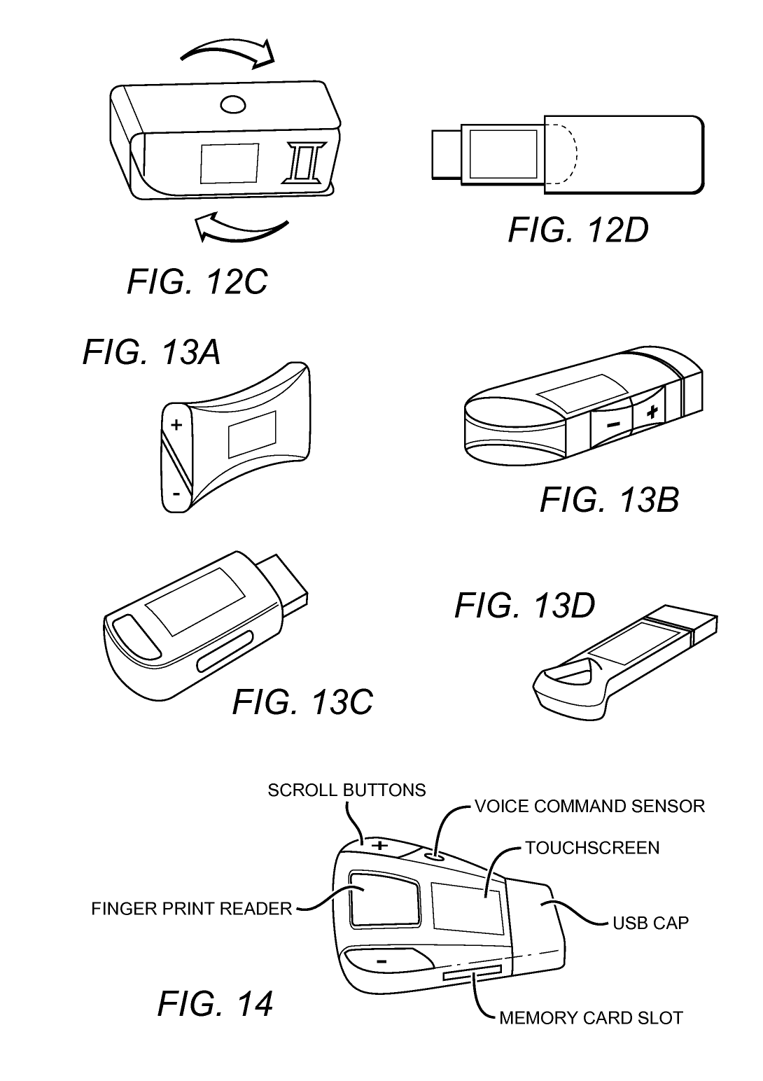

FIGS. 4 through 14 show other embodiments and designs of portable devices for storing confidential data.

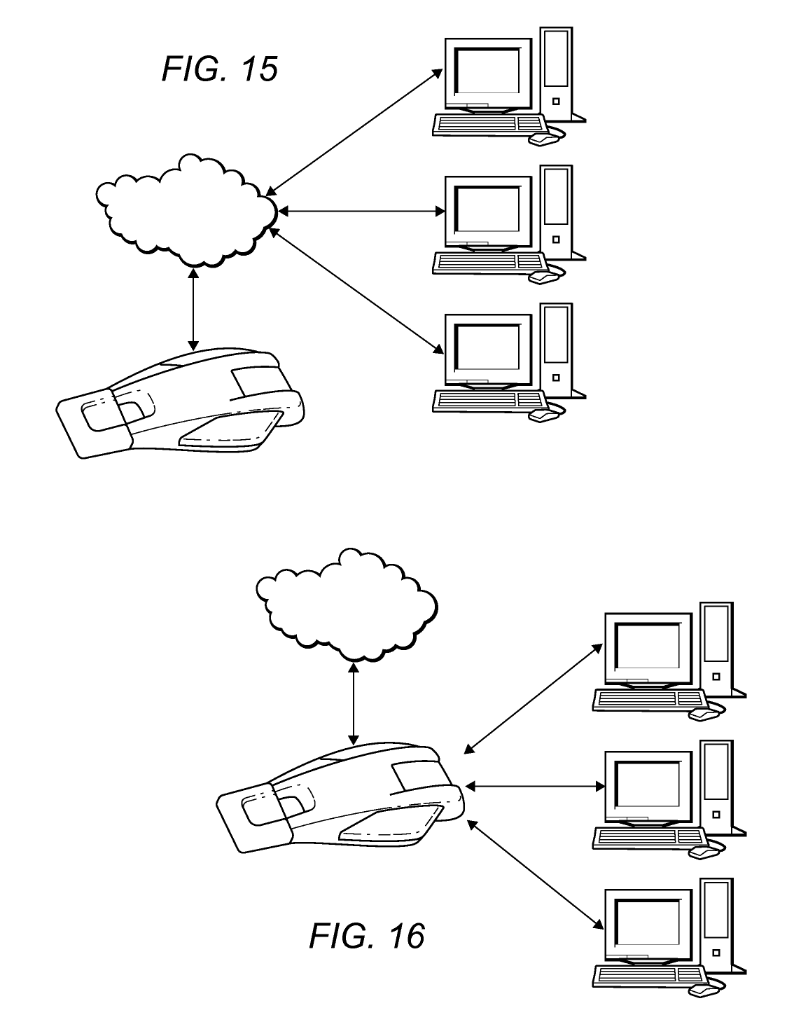

FIG. 15 shows a system wherein a device of the inventive subject matter is communicatively coupled to a cloud server. The cloud server comprises a confidential data storage medium and is communicatively coupled to at least three third party servers. In this and some other embodiments, a batch of passwords or contact information associated with the third party server(s) can be input, generated, or updated via software.

FIG. 16 shows another system wherein a device of the inventive subject matter is communicatively coupled to a cloud server comprising a confidential data storage medium. The device also comprises a confidential data storage medium and is communicatively coupled to at least three third party servers.

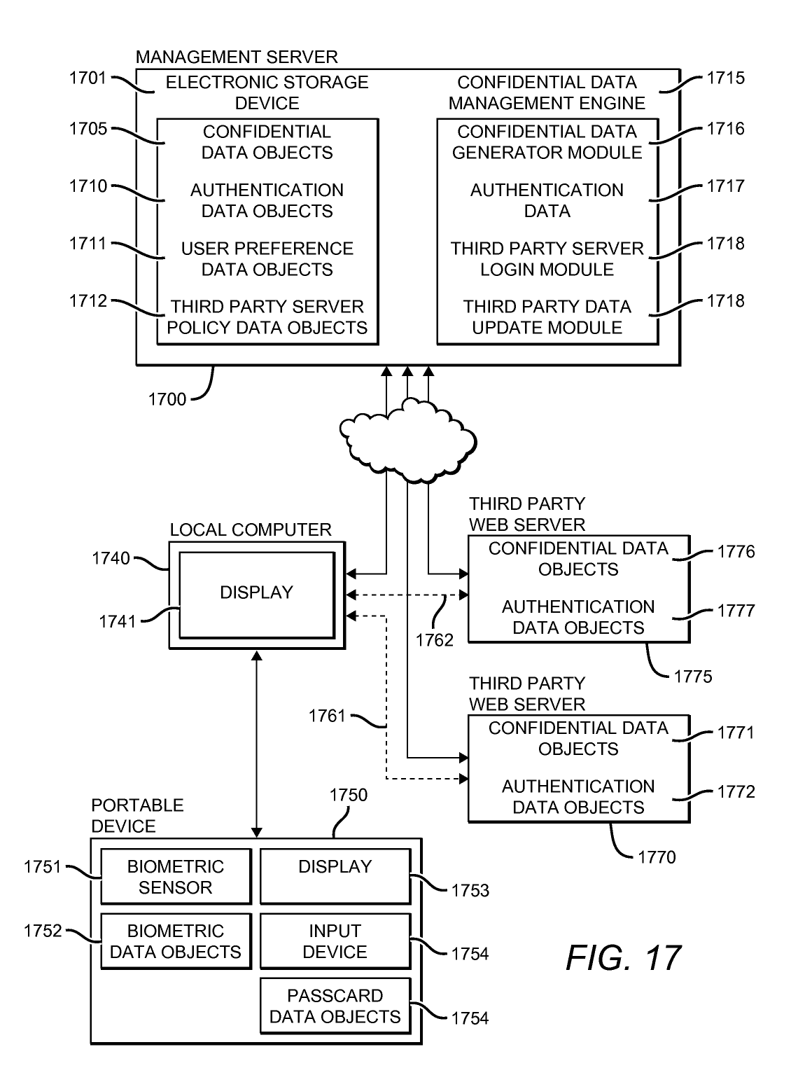

FIG. 17 shows a schematic of a management server 1700 for managing confidential data and other user data. Management server 1700 has a storage device 1701 for storing confidential data objects 1705, authentication data objects 1710, and other data objects necessary for its operation. Confidential data objects 1705 can include confidential information related to a user, such as bank account numbers, credit card pin numbers, answers to authentication questions (e.g., mother's maiden name, name of childhood pet, name of street where you grew up, etc.), health data (e.g., medical insurance policy numbers, blood type, medical conditions, medical history, etc), usernames and passwords for logging into third party websites, or any other confidential information.

Confidential data objects 1705 can be organized in groups and/or hierarchies using predetermined rules, defined by the user or by a managing entity (i.e., the entity that creates and/or controls server 1700). Examples of organization schemes can include groupings by data type (e.g., banks, e-commerce websites, health data, etc.), by date of creation, or by any other organizational scheme suitable for the user's preferences.

Authentication data objects 1710 comprise data that can be used to authenticate a user identity to allow the user to access and use confidential data objects 1705. In some embodiments, authentication data objects 1710 includes biometric data about the user (e.g., fingerprint, voice pattern, blood make-up, genetic sequence, eye scan, etc.). The biometric data can be obtained from the user via a local and physical interaction. For example, the user could visit a facility controlled by the managing entity and provide the biometric data using sensors at the facility. The managing entity could then store the biometric data on storage device 1701 using a wired private connection. Alternatively, the biometric data could be provided remotely over a public wide area network via a secured communication (e.g., encryption, virtual private network, etc.).

In other embodiments, authentication data objects 1710 comprises a data set that must be combined with a second data set stored on en external object (e.g., portable device 1750) before it can provide a user with access to data objects 1705. In such embodiments, the combination of the two data sets is referred to as a “passcard,” wherein each data set only represents a portion of the “passcard.” In application, the managing entity creates a passcard and stores one half of the passcard on a storage medium within portable device 1750 prior to selling portable device 1750 to a user (or prior to giving up physical control of portable device 1750). In other applications, the managing entity can store half of the passcard on the portable device 1750 after the sale of the device, such as by a secured wired connection or an encrypted communication via a public wide area network (e.g., world wide web). The other data set can be stored on storage device 1701 at any time prior to a user's communication with server 1700.

Server 1700 also has a processor that runs confidential data management engine 1715. Engine 1715 comprises various executable instructions (i.e., software code) organized into “modules.” The various modules can be accessed and used by a user via portable device 1750. Portable device 1750 comprises a thumb drive-sized device that has a USB port, a display 1753, and an input device 1754 (e.g., buttons), a biometric sensor 1751 (e.g., fingerprint reader), and an electronic storage medium. In practice, the user connects portable device 1750 to local computer 1740 (e.g., a desktop computer, laptop, tablet, etc.) that has internet connectivity. The user then provides a biometric data (e.g., fingerprint). Portable device 1750 reads the biometric data using sensor 1751 and generates biometric data objects 1752, which can then be communicated to server 1700 for authentication. Once authenticated, engine 1715 can be accessed via a graphic user interface displayed on display 1741.

In alternative embodiments, portable device 1750 includes sufficient characteristics (e.g., processing capabilities, electronic storage capacity, internet connectivity, display size/resolution, etc.) such that local computer 1740 is not needed for interacting with server 1700. For example, portable device 1750 could comprise a smart phone, tablet, or laptop. In such embodiments, portable device 1750 can communicate with server 1700 directly and a user could access and utilize engine 1715 via display 1753 and input device 1754.

Those of skill in the art will appreciate that display 1753 and input device 1754 could comprise a touch screen display that displays information and allows a user to input commands and data. Input device 1754 could also comprise a keyboard, microphone and voice recognition software, mouse, or any other hardware and/or software configuration that allows the user to interact with device 1750.

Once authenticated, the user can access, configure, and utilize the various modules provided by engine 1715. Confidential data generator module 1716 allows the user to generate new confidential data objects, such as new passwords, for accounts and third party websites. For example, by sending one command (e.g., clicking one button on a graphic user interface) the user can instruct engine 1715 to generate a new batch of passwords that are stored in storage device 1701 as password objects. The user can then send a command to third party server login module 1718, which automatically authenticates the user with respect to third party websites (e.g., server 1770 and server 1775) using authentication data 1717 (i.e., previous batch of passwords). Finally, the user can send a command to third party data update module 1718, which automatically updates confidential data objects 1771 and 1777 stored on third party web servers 1770 and 1775 with the newly generated password data objects. In this manner, management server 1700 allows a user to simultaneously update multiple passwords corresponding to multiple third party servers with one command or series of commands. The user may choose to configure module preferences so that, with just one command (e.g., one click), the user can generate new passwords for many different websites and automatically update the third party websites' password data without having to manually log onto each website.

Those of skill in the art will appreciate that engine 1715 can manage data other than passwords. For example, engine 1715 could be used to update a home address after a residential move, for multiple websites and/or accounts, without having to manually log onto each website or account. Engine 1715 could also be used to update a name (e.g., after changing a last name due to marriage), social security number, credit card number, or any other data of interest to the user. Engine 1715 provides a process and system that securely stores confidential data relevant to multiple entities (e.g., multiple third party servers), and allows the user to manage (e.g., update, delete, create, etc.) the confidential data from a central location.

In other embodiments, the user may choose to define user preferences such that engine 1715 runs automatically at specified intervals without additional user instructions (i.e., engine 1715 operates in the background). Server 1700 allows the user to define numerous preferences as user preference data objects 1711 on storage device 1701. In other aspects, the user may choose to define preferences such that, when portable device 1750 is connected to local computer 1740 and biometric data is provided, display 1741 automatically logs the user into servers 1770 and 1775 and displays two logged-in webpages in a web browser. In this mode, portable device 1750 acts as a virtual key, meaning that when portable device 1750 is plugged into a computer, the user is automatically authenticated with multiple web servers (via server 1770) without having to manually enter passwords or authentication data for each webpage (other than the biometric data previously provided). When portable device 1750 is disconnected from local computer 1740, then server 1770 logs the user off the third party websites and closes the web browser windows. In this mode, server 1700 acts as an authentication engine for multiple third party servers runs in the background such that the user perceives a direct connection with the third party servers via display 1741 on local computer 1740 (i.e., connections 1761 and 1762 can be a “virtual” connection).

Third party data update module 1718 could operate by running intelligent script that automates the process of: (i) opening a website on a browser, (ii) entering in authentication data (e.g., user name, password, answers to security questions) in order to log into the website, (iii) once logged in, clicking on a link to access a user profile, (iv) entering in the updated confidential data (e.g., password, home address, etc.), and (v) clicking on a “save” link that instructs the third party website to save the updated information.

In alternative embodiments, third party data update module 1718 could operate by interacting with a module stored on the third party server (e.g., server 1770 or 1775), which has been specifically configured to allow module 1718 to update confidential data (e.g., confidential data objects 1771 and 1776). In this embodiment, the third party servers have previously agreed to cooperate with module 1718 by running an addon or module that accepts interactions with server 1700. The cooperation policy between server 1700 and the third party servers could be unique for each relationship. For example, a bank website may want to require an extra authentication step with module 1718, before allowing module 1718 to update the confidential data objects stored on the banking website. On the other hand, a non-commercial gaming website that does not store highly sensitive/private user data may accept management server 1700 instructions without providing authentication beyond the user's authentication with server 1700 (e.g., the authentication process that relies on biometric data objects 1752 and/or passcard data objects 1754). Server 1700 is capable of storing policies for handling unique interactions with each third party server.

In alternative embodiments, engine 1715 and confidential data objects 1705 can be stored directly on portable device 1750, essentially eliminating or reducing the need for server 1700. In such embodiments, portable device 1750 can be used to directly communication with third party servers 1770 and 1775 for accessing, managing, and updating, confidential data objects 1771 and 1776, respectively. Modules 1716-1718 can be accessed, re-configured, and otherwise utilized or managed via display 1753 and/or input device 1754.

In yet other alternative embodiments, engine 1715 and confidential data objects 1705 can be stored on local computer 1740. Local computer 1740 is physically accessible to the user such that the user can physically connect portable device 1750 to local computer 1740. However, portable device 1750 could also (or alternatively) connect with local computer 1740 via a wireless protocol (Bluetooth®) and could even access local computer 1740 via a public wide area network (e.g., using WiFi via the internet or via a cellular network). Those of ordinary skill in the art will appreciate that numerous methods, systems, protocols, communication systems, encryption methods, and the like can be used to establish a secure communication between numerous devices.

### Biometric Authentication

In another aspect of the invention, an authentication device for using biometric information (e.g., fingerprints, irises, etc.) to authenticate users is presented. Specifically, the authentication device authenticates a user based on the user's biometric information without persistently storing any biometric data (or its derivatives) of the user on the device's non-volatile (i.e., persistent) storage (e.g., hard drive, flash memory, etc.). Since no biometric data is persistently stored on the device's non-volatile storage, the authentication procedure is more secure and is less likely that potential intruders can access biometric data of the users. In some embodiments, the authentication device is part of the portable device 100, 200, or 300 as referenced by FIGS. 1, 2, and 3 above.

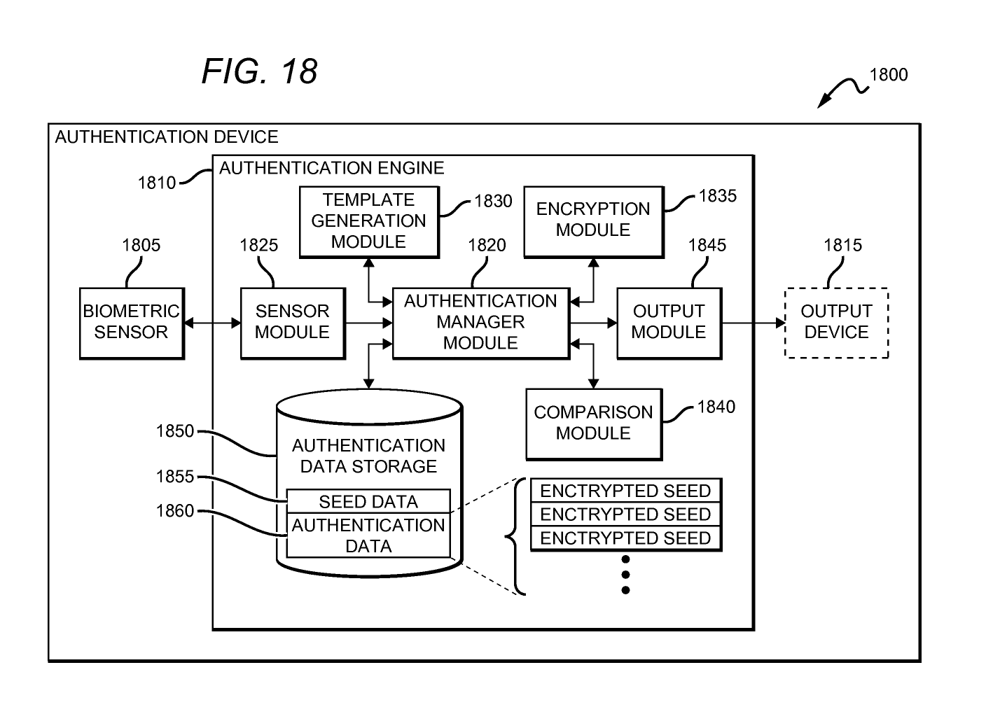

FIG. 18 illustrates an authentication device 1800 of some embodiments. The authentication device 1800 includes a biometric sensor 1805 and an authentication engine 1810. In some embodiments, the authentication device 1800 also includes an output device 1815 (e.g., a display, a light, a speaker, etc.). In other embodiments, the authentication engine 1810 is communicatively connected to (through electrical wire or through wireless connection) a separate output device 1815 (e.g., a display monitor that is connected to the authentication device).

The authentication engine 1810 includes an authentication manager module 1820, a sensor module 1825 that is communicatively coupled to the biometric sensor 1805 for receiving biometric images from the biometric sensor 1805, a template generation module 1830, an encryption module 1835, a comparison module 1840, an output module 1845 that is communicatively coupled to the output device 1815, and an authentication database 1845.

In some embodiments, the authentication manager module 1820, the sensor module 1825, the template generation module 1830, the encryption module 1835, the comparison module 1840, and the output module 1845 are implemented as software programs that are executable in at least a processing unit (e.g., a microprocessor, etc.). In some embodiments, the authentication data storage 1850 is an electrical storage that can comprise a file system, database management system, a document, a table, etc. The data storage 1850 of some embodiments is implemented in a non-transitory data storage such as a hard drive, a flash memory, etc. The authentication data storage 1850 of some embodiments is configured to store seed data and authentication data.

Biometric authentication is a two-staged process: enrollment and verification. During the enrollment process, the authentication device 1800 acquires initial biometric data from a user to create the authentication data. When the authentication device 1800 subsequently receives authentication request in the form of new biometric data from either the same user or another user (e.g., a non-authorized user), the authentication device 1800 uses the newly acquired biometric data to verify the user's identity. The enrollment process and the verification process will be discussed in more detail in the following sections below.

### Enrollment

The enrollment process begins when the authentication device 1800 receives an enrollment initiation event (e.g., receiving an enrollment request from a user, activating of the biometric sensor for the first time, etc.). Upon receiving the enrollment initiation event, the authentication manager module 1820 notifies the sensor module 1825 to retrieve biometric data from the biometric sensor 1805. The biometric sensor is a device that is configured to acquire a biometric data (e.g., fingerprint data, iris data) from a user. The biometric data can take many forms, it can comprise a 2D or 3D image (e.g., an image of a fingerprint, an image of an iris, a 3D image of a mold taken from a dental impression), or it can comprise data extracted from the image. Examples of a biometric sensor include an optical scanner and a capacitance scanner.

Once biometric data (e.g., a fingerprint image, an iris image, etc.) is acquired by the sensor module 1825, the sensor module 1025 of some embodiments first adjusts the biometric data if necessary (e.g., aligning the fingerprint image, etc.). The sensor module 1025 then sends the adjusted biometric data to the authentication manager module 1820. Upon receiving the biometric data, the authentication manager module 1820 sends the biometric data to the template generation module 1830 to generate multiple biometric templates based on the acquired biometric data.

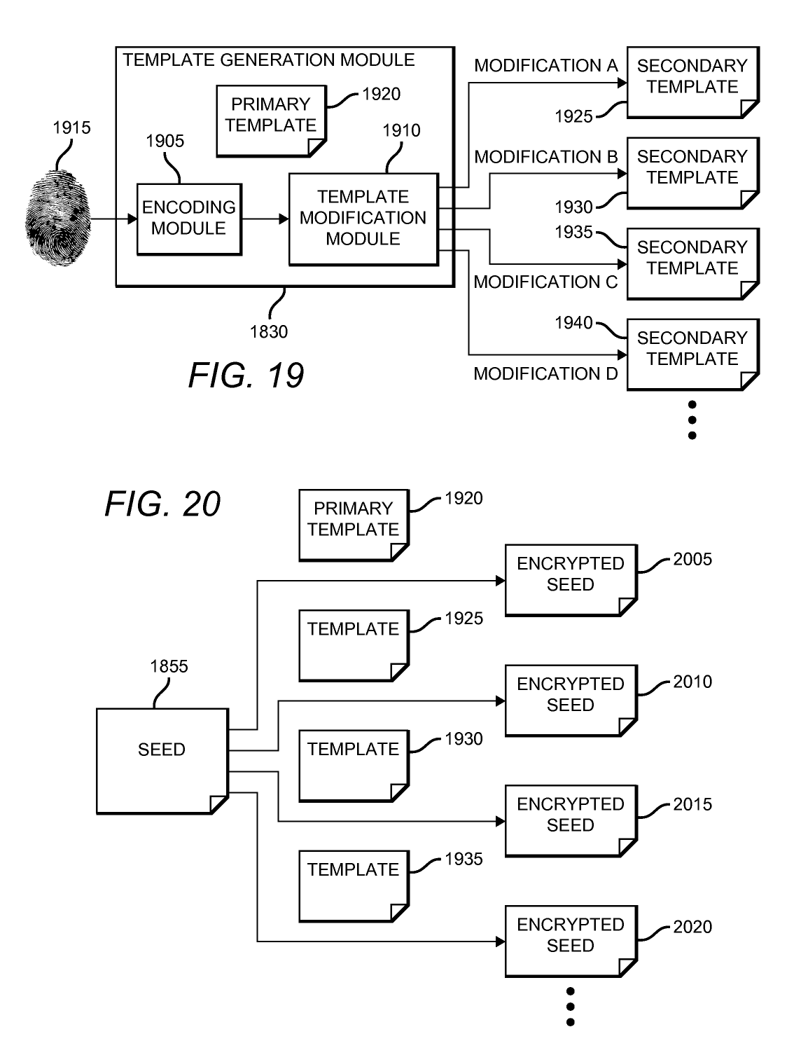

FIG. 19 illustrates the process of creating multiple biometric templates based on the acquired biometric data performed by the template generation module 1830 of some embodiments. In some embodiments, the template generation module 1830 includes an encoding module 1905 and a template modification module 1910. The process begins with receiving, at the encoding module 1905, an adjusted biometric data, such as an aligned or enhanced fingerprint image 1915 (e.g., the fingerprint image 1915 has been slightly rotated or shifted in the horizontal and/or vertical directions, contrast has been adjusted, etc.). Based on the adjusted biometric data, the encoding module 1905 creates a primary template 1920.

A biometric template is a digital representation of distinct characteristics extracted from the acquired biometric data. Since biometric data such as fingerprint patterns or iris patterns often carries a huge amount of data (and most of that data does not pertain to distinctive characteristics), the encoding module 1905 is configured to generate a template for the biometric data by extracting information from only a few distinctive portions of the biometric data.

Different embodiments use different techniques to generate a template from a biometric image. In some embodiments, the encoding module 1905 extracts locations of distinctive features (e.g., loops, whorls, arches, break points, bifurcations, intersections, etc.). In some of these embodiments, the encoding module 1905 divides the biometric image into different zones, where each zone is associated with a unique coordinate. The encoding module 1905 then records the zone coordinates having the distinctive features.

In other embodiments, in addition to recording the coordinate information, the encoding module 1905 extracts certain characteristics of the biometric image. For example, the encoding module 1905 of some embodiments extracts a slope angle or curvature of the fingerprint grooves in several pre-determined zones of the biometric image.

A template for an iris image can also be generated in similar fashions. More information on creating templates based on biometric data can be found in an article entitled “Biometric Encryption” by Soutar et al., published in 1999, which is entirely incorporated by reference herein.

The template that is generated directly from the acquired biometric data will be referred to as the primary template hereinafter. Once the primary template (such as primary template 1920 that is created from the adjusted biometric data acquired from fingerprint image 1915) is created, the template generation module 1830 generates several (e.g., one hundred, one thousand, etc.) other secondary biometric templates. Each of these secondary templates is generated by applying a different modification (e.g., slightly adjusting the slope value associated with different encoded pixels, adding or removing an indicator representing the presence of a unique feature such as a break point or bifurcation, etc.) to the acquired biometric image or the primary template. As shown in FIG. 19, the template modification module 1910 of some embodiments takes the primary template 1920 and applies different modifications to the primary template 1920 to form secondary templates 1925-1940.

The secondary templates take into account the fact that each biometric image acquired from the sensor 1805 can be distorted slightly or have slight variations. For example, fingerprint images of the same user that are acquired from the biometric sensor 1805 can have different distortions when the user applies different pressure on the finger during the scanning processes. Other variations may result from the user swiping the finger at different speeds and directions. Optical aberrations or noises can also be introduced during the scanning process. Yet other variations might occur from an unclean finger or screen. The purpose of generating the secondary templates is to emulate the effect of acquiring multiple biometric images from the same user, where each biometric image is slightly different from one another due to distortions and variations in the scanning protocol.

Different modifications can be applied to the image (or the template) to form different secondary templates. For example, the template modification module 1910 can adjust the locations of the distinctive features (e.g., moving the location of a bifurcation one zone to the top, to the bottom, to the left, and/or to the right). The template modification module 1910 can also remove certain distinctive features (e.g., bifurcations, end points, etc.) from the primary template. The template modification module 1910 can also adjust the features of the biometric data in some embodiments. For example, the template modification module 1910 can adjust the slope angle or curvature of a fingerprint groove (by different degrees) to generate a derived secondary template. The primary template and the secondary templates form the initial template set. However, it is also contemplated that in some alternative embodiments the primary template is not part of the initial template set and is immediately discarded (e.g., electronically deleted) once the secondary templates are created.

In one embodiment, the initial template set becomes the authentication data, against which subsequent acquired biometric data will be compared.

In another embodiment, the initial template set, excluding the primary template, will form the authentication data (the primary template is discarded after the secondary templates are generated). This embodiment has the benefit of not storing the primary template created from the acquired biometric image on the device. In addition, in some of these embodiments, the authentication data is encrypted when stored on the device for additional security.

In the embodiments mentioned above, biometric data of the user (in the form of templates or encrypted templates) are stored on the device in order to perform subsequent authentication procedures. One disadvantage of this implementation is that it allows potential intruders to access biometric data of the user. Therefore, it is contemplated that in some embodiments, the templates in their current states are not being used as authentication data. Instead, the authentication manager module sends the initial template set to the encryption module 1835 to perform additional operations.

In some embodiments, the encryption module 1835 uses each template in the initial template set as an input to perform an irreversible operation and produce an output. The authentication manager module 1820 then stores these outputs as authentication data for subsequent authentication procedures. The irreversible operation has the following characteristics: (1) the operation will generate identical outputs for identical inputs; (2) after the operation is performed, it is impossible (or extremely difficult) to determine the input from the output; and (3) the operation will generate different outputs for different inputs.

Examples of these irreversible operations include: (1) encrypting a seed using each template as an encryption key to produce an encrypted seed, (2) using a public key to encrypt each template and destroying the private key, and (3) producing a checksum using the template. These three different operations will be discussed in more detailed below. Although only three operations are discussed here, it is contemplated that other irreversible mathematical operations can be used to perform the step of using the initial template set as an input to perform an irreversible operation and produce an output.

Under the first approach, the encryption module 1835 encrypts a seed using each template in the initial template set as an encryption key to produce an encrypted seed. In some embodiments, the seed is an arbitrary string of characters and/or numerals, which can either be provided by the user or randomly generated by the authentication manager module 1820. Preferably, the seed has a length of at least ten (10) characters/numerals. After generating or receiving the seed, the seed (such as seed 1855) is stored in the authentication data storage 1850. The encryption module 1835 is configured to encrypt the seed using the templates from the initial template set as encryption keys to generate a set of encrypted seeds. As shown in FIG. 20, the seed 1855 is being encrypted using the different templates (such as templates 1920, 1925, 1930, and 1935) to generate encrypted seed 2005, encrypted seed 2010, encrypted seed 2015, encrypted seed 2020, and so forth. Each of the encrypted seed is generated by encrypting the seed using a different template from the template set as encryption key. The authentication manager module 1820 then stores the set of encrypted seeds in the authentication data storage 1850 as the initial authentication data 1860.

Under the second approach, the encryption module 1835 uses an asymmetric key encryption scheme (e.g., a public-key cryptography) to encrypt the templates in the initial template set to generate a set of encrypted templates. The private key associated with the encryption scheme will be destroyed so that the encrypted templates cannot be decoded afterwards. The set of encrypted templates are stored in the authentication data storage 1850 as authentication data.

Under the third approach, the encryption module 1835 produces a checksum for each template in the initial template set. The checksum for each template is a small-size datum computed from bit-level data of the template. A different template should produce a different checksum (as long as the size of the checksum is large enough to cover the number of different templates). The checksum is then stored in the authentication data storage 1850 as authentication data.

One of the purposes of authenticating a user at the authentication device 1800 is to allow the user to access data that is either stored on the device 1800 or on a different device that is communicatively connected with the authentication device 1800. The data that the user is trying to access is often encrypted for security reasons, and the authentication process involves providing to the user a key (hereinafter the “Data Access Key”) for decrypting the encrypted data once the user is authenticated. It is contemplated that the authentication device 1800 can provide the user with the Data Access Key without storing the Data Access Key in a clear text format (or stored in a format from which non-authenticated users can derive the Data Access Key) by using a variation of the authentication process under the first approach.

In some of these embodiments, the authentication engine 1810 uses the different templates in the template set as encryption keys to encrypt different variants of the Data Access Key. A variant of the Data Access Key is generated by omitting some data from the Data Access Key such that none of the variants by itself present the entire Data Access Key. Different variants include different portions of the Data Access Key. In some embodiments, the different portions of the Data Access Key between different variants can be overlapping. In some embodiments, each variant can also include a validity indicator.

To illustrate this concept, an example Data Access Key that comprises the character string “f012abcd” will be used in the following discussion. For this Data Access Key, the encryption module 1835 would generate multiple variants, such as “_{—}0_{—}2_b_d:VALID”, “f0_ab_:VALID”, “_{—}0_{—}2_cd:VALID”, and f_{—}1_a_c_:VALID”. As shown, the first portion of each variant (e.g., “_{—}0_{—}2_b_d” of the first variant) includes a portion of the Data Access Key. In each of these variants, the character “_” denotes an omitted character from the Data Access Key. As shown, each variant includes only a portion of the Data Access Key. In addition, each variant also indicates which portion of the Data Access Key is missing by using the “_” character. Each variant also includes a second portion (e.g., “:VALID”) to indicate that this is a valid variant during the verification stage, which will be discussed in more detail in the following section below.

The variants of the Data Access Key are designed in such a way that more than one, but not all, of the variants is needed in order to re-construct the Data Access Key. In the example given above, if one has obtained only the first two variants, “_{—}0_{—}2_b_d:VALID” and “f0_ab_:VALID”, one can only reconstruct a partial Data Access Key “f0_{—}1ab_d”. However, having obtained the first three variants, “_{—}0_{—}2_b_d:VALID”, “f0_ab_:VALID”, and “_{—}0_{—}2_cd:VALID”, one can reconstruct the Data Access Key in its entirety “f012abcd”. Similarly, having only the second and third variants, “f0_ab_:VALID” and “_{—}0_{—}2_cd:VALID”, cannot produce a complete Data Access Key, but with an additional variant such as the fourth variant “f_{—}1_a_c_:VALID”, one can reconstruct the complete Data Access Key “f012abcd”.

Additionally, it is contemplated that one can adjust the number of omitted characters in each variant and/or the length of the Data Access Key to control how many (or the percentage of) variants one need to obtain in order to successfully reconstruct the Data Access Key.

The encryption module 1835 then uses the templates in the template set to encrypt the Data Access Key variants. In some embodiments, a different template in the template set is used as encryption key to encrypt a different Data Access Key variant. In some embodiments, a symmetric encryption algorithm is used to encrypt the Data Access Key variants such that templates that are identical to the templates in the template set can be used to subsequently decrypt the encrypted Data Access Key variants to reconstruct the Data Access Key.

As a result of the encryption procedure, a set of encrypted Data Access Key variants are generated. In some of these embodiments, the authentication manager module 1820 stores these encrypted variants in the authentication data storage 1850 as the authentication data. In addition, the Data Access Key and its variants in their clear text format will be discarded (i.e., electronically removed) from the authentication device 1800.

To provide an additional layer of security, instead of using the Data Access Key directly, the authentication engine 1810 of some embodiments first encrypts the Data Access Key using another encryption key (hereinafter the “PassKey”), and stores the encrypted Data Access Key on the device. The authentication engine 1810 then performs the same process described above on the PassKey, rather than on the Data Access Key directly. In these embodiments, the set of encrypted PassKey variants are stored in the authentication data storage 1850 as the authentication data.

### Verification

Verification begins when a user (either an authorized or non-authorized user) is accessing the authentication device 1800 after the enrollment procedure is complete. When the user tries to access the authentication device 1800, the device 1800 will prompt the user for a biometric scan (e.g., fingerprint scan or iris scan). Referring back to FIG. 18, the sensor module 1825 is configured to acquire biometric data (e.g., fingerprint image or iris image) from the biometric sensor 1805. After aligning the image, the sensor module 1825 sends the image to the authentication manager module 1820. The authentication manager module 1820 sends the aligned image to the template generation module 1830 to generate a new template set using the methods described above by reference to FIG. 19. In the embodiments in which the template set is stored on the device as authentication data, the authentication manager module 1820 uses the comparison module 1840 to compare the newly generated template set against the initial template set stored in the authentication data storage 1850.

In some embodiments, a complete match between the newly generated template set and the initial template set is not required to authenticate the user. The authentication device 1800 can be configured to authenticate a user when the two template sets overlap by a certain threshold (e.g., 80%, 70%, etc.). Thus, when the comparison module 1840 determines that the two template sets overlap by the threshold, the authentication manager module 1820 uses the output module to indicate that the user is authenticated (e.g., by configuring an output device to indicate authentication is complete to the user).

In some of the other embodiments in which the template set is not stored in the authentication device 1800 as authentication data, the authentication manager module 1820 is configured to perform the same irreversible operation (e.g., public key encryption, encrypting a seed using the templates as keys, or checksum, etc.) with the new template set. The generated outputs from the irreversible operations (e.g., the encrypted templates, the encrypted seeds, or the checksums, etc.) will be compared against the authentication data stored on the device 1800 by the comparison module 1840. Similar to the comparison of templates, it is not required that all encrypted seeds in the newly generated set match with the stored encrypted seeds. The authentication manager module 1820 is configured to authenticate a user when the newly generated encrypted seeds overlap with the stored encrypted seeds by a certain threshold (e.g., 80%, 70%, etc.). When determined that the newly generated encrypted seeds and the stored encrypted seeds have enough overlap, the authentication manager module 1820 instructs the output module 1845 to present an indication that the user is authenticated (e.g., configure an output device to display an indication that the user is authenticated).

In the embodiments in which encrypted variants of the Data Access Key or encrypted variants of the PassKey are used as authentication data, the authentication manager module 1820 is configured to instruct the encryption module 1835 to decrypt the encrypted variants using templates from the new template set as decryption keys. In some embodiments, the encryption module 1835 is configured to attempt decrypt each encrypted variant multiple times, each time using a different template from the new template set as decryption key. If the new template set includes a template that is identical to the one used to encrypt the variant during the enrollment process, a valid variant will be produced. The validity of a variant can be determined by the validity indicator as described above. In the example provided above, a valid indicator included in the decrypted text (e.g., the string “:VALID” appended at the end of the decrypted text) would indicate to the encryption module 1835 that the decrypted text is a valid variant.

The encryption module 1835 is configured to decrypt each encrypted variant using the same process to obtain valid variants. As mentioned above, the variants are usually designed in such a way that a percentage (a threshold) of different valid variants is required in order to successfully reconstruct the complete Data Access Key. Therefore, the encryption module 1835 is able to recover enough valid variants to reconstruct the complete Data Access Key as long as the new template set and the initial template set overlaps by more than the threshold.

Once the Data Access Key is obtained, the new template set is discarded from the authentication device 1800. The Data Access Key can then be used to access user data as desired during the current session, and will also be discarded from the authentication device 1800 after it has been used. The same process as described above can be used to retrieve the PassKey.

Instead of or in addition to the biometric authentication scheme as described above, the authentication device 1800 can be configured to authenticate a user based on a tapping pattern on the device. In these embodiments, the authentication device 1800 also includes an accelerometer to detect vibrations on the device caused by the tapping (e.g., tapping by a user's finger on the device). During the enrollment process, the authentication engine 1810 can record a tapping sequence (pattern) and store information about the pattern in the authentication data storage 1850 as part of the authentication data 1860. During the verification process, the authentication device 1800 receives a tapping pattern from the user again, and compares the newly received tapping pattern against the tapping pattern stored in the authentication data storage 1850.

In order to increase security, it is also contemplated that more than one fingerprint (e.g., the thumb and index finger) are used for the authentication process described above. In some of these embodiments, not only the biometric information on the fingerprints is used as authentication data, but the sequence in which the fingers are scanned can also be used as authentication data. For example, during the enrollment process, the user can first scan her index finger, then the thumb, then the middle finger for the authentication device 1800 to generate the authentication data. Subsequently, when the user is scanning her fingers on the authentication device for verification, the authentication device 1800 verifies not only the validity of the fingerprints, but also the order in which the user scans the fingers, before the device 1800 authenticates the user.

In some embodiments, the authentication data 1850 could comprise a combination of a tapping pattern and a fingerprint sequence. During the enrollment process the user provides a unique combination of tapping and finger print sequences that must be repeated during the authentication process. In yet other embodiments, the tapping can be provided by the user via buttons rather than an accelerometer.

It is contemplated that the authentication methods and devices described herein can be used to provide access to both physical and digital space/data. For example, in one scenario, the user could use the authentication devices and methods to open up a garage door, front door, or a gate. After providing the biometric data to the portable biometric reader (e.g., swiping a finger or sequence of fingers), the device performs an authentication protocol and authorizes the user to open the door or gate by sending a radio frequency code to an automatic door unlock or opener.

In a similar scenario, a user could use the authentication devices and methods described herein to simultaneously access multiple spaces and/or data. For example, as the user returns to his or her home after work, the user could swipe a finger on a portable authentication device to automatically disalarm a security system, unlock and open the garage door, turn on a living room light, turn on the heater, and log the user onto a personal computer. The portable device is preferably configured to use one finger print swipe (or one authentication input such as a sequence of swipes or taps) to simultaneously authentication the user with multiple devices. It is further contemplated that the portable device can communicate directly with each external resource (e.g., security system, garage door, lighting, heater, computer, etc.), or indirectly via a network. In some applications the portable authentication device can be configured to detect proximity with the user's home, such that when the user swipes his or her finger, the portable device automatically authenticates the user with multiple resources via preset rules, without any further input from the user (e.g., the user does not have to provide an additional input to authenticate with, and access, each resource).

In some applications of the devices and systems described above, the portable device is configured to simultaneously access multiple digital resources using one authentication input. For example, a user can provide a finger print (e.g., one authentication input) and the device will securely log the user onto multiple third party websites (e.g., social network website, banking website, ecommerce website, etc.). The portable device can communicate with the third party websites indirectly (e.g., auto-filling a login page using a pre-stored username and password) or directly (e.g., the third party websites have a cooperative agreement with the user's portable device or with a server accessible to the portable device).

The devices and methods described herein provide numerous advantages from the user's perspective. First, the authentication is simplified by eliminating the need to memorize passwords and usernames. Instead, the user provides a biometric input. Second, a portable biometric device can be used as a universal key to access both digital and physical spaces and data. Third, the devices and methods described herein are capable of eliminating the need to have multiple authentication devices or keys (e.g., car keys, house keys, passwords, user names, etc.). Fourth, the devices and methods inherently possess the high level of security provided by biometric data authentication, without requiring biometric scanners at every resource. Fifth, the user can simultaneously authenticate with multiple external devices that each have their own authentication requirements.

Unless the context dictates the contrary, all ranges set forth herein should be interpreted as being inclusive of their endpoints and open-ended ranges should be interpreted to include only commercially practical values. Similarly, all lists of values should be considered as inclusive of intermediate values unless the context indicates the contrary.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A portable authentication device for authenticating a user, comprising:
a biometric sensor;
a storage configured to store a set of authentication data; and
an authentication engine communicatively coupled to the storage and configured to:
create a first plurality of templates based on first biometric data of the user captured from the biometric scanner;
transform the set of authentication data using the first plurality of templates to produce a set of transformed authentication data;
determine an authentication status of the user based on the transformed authentication data; and
configure an output device to indicate the authentication status of the user.

2. The portable authentication device of claim 1, wherein the biometric sensor is a fingerprint scanner.

3. The portable authentication device of claim 1, wherein the biometric sensor is an iris scanner.

4. The portable authentication device of claim 1, wherein the authentication engine is further configured to:
derive a first primary template using the first biometric data; and
create the first plurality of templates comprising the first primary template and a set of different secondary templates created by applying different modifications to the first primary template.

5. The portable authentication device of claim 1, wherein the authentication engine is configured to transform the set of authentication data by decrypting the set of authentication data using the first plurality of templates as decryption keys to produce the set of transformed authentication data.

6. The portable authentication device of claim 5, wherein each transformed authentication data in the set of transformed authentication data comprises a portion of a passcode.

7. The portable authentication device of claim 6, wherein the passcode comprises a key for accessing encrypted data stored on the portable device.

8. The portable authentication device of claim 6, wherein the authentication engine is further configured to determine a valid authentication status for the user if the set of transformed authentication data forms the complete passcode.

9. The portable authentication device of claim 1, wherein the authentication engine is further configured to:
create a second plurality of templates based on second biometric data of the user captured from the biometric scanner prior to capturing of the first biometric data;
generate a set of variant passcodes from the passcode, wherein each variant passcode in the set of variant passcodes comprises a different portion of the passcode;
encrypt the set of variant passcodes using the second plurality of templates as encryption keys to produce a set of encrypted variant passcodes;
store the set of encrypted variant passcodes in the storage as the authentication data; and
delete the second plurality of templates and the passcode from the portable authentication device.

10. The portable authentication device of claim 1, wherein the authentication engine is further configured to display, on the authentication device, data that has been decrypted using the passcode.

11. A method of authenticating a user using a portable authentication device that stores authentication data, the method comprising:
capturing, at the portable authentication device, biometric data from the user;
creating a first plurality of templates based on the captured biometric data;
transforming the set of authentication data using the first plurality of templates to produce a set of transformed authentication data;
determining an authentication status of the user based on the set of transformed authentication data;
configuring an output device to indicate the authentication status of the user.

12. The method of claim 11, wherein the step of creating the first plurality of templates comprises:
deriving a first primary template using the first biometric data; and
creating the first plurality of templates comprising the first primary template and a set of different secondary templates created by applying different modifications to the first primary template.

13. The method of claim 11, wherein transforming the set of authentication data comprises decrypting the set of authentication data using the first plurality of templates as decryption keys to produce the set of transformed authentication data.

14. The method of claim 13, wherein each transformed authentication data in the set of transformed authentication data comprises a portion of a passcode.

15. The method of claim 14, wherein the passcode comprises a key for accessing data stored on the portable authentication device.

16. The method of claim 14, wherein determining the authentication status of the user comprises determining a valid authentication status if the set of transformed authentication data forms the complete passcode.

17. A method of enrolling a user to a portable authentication device for subsequent authentications, the method comprising:
capturing, at a biometric sensor of the portable authentication device, biometric data from the user;
creating a first plurality of templates based on the captured biometric data;
generating a set of variant passcodes from a passcode, wherein each variant passcode in the set of variant keys comprises a different portion of the passcode;
encrypting the set of variant keys using the first plurality of templates as encryption keys to produce a set of encrypted variant keys;
storing the set of encrypted variant keys in a storage of the portable authentication device as authentication data; and
deleting the first plurality of templates and the passcode from the portable authentication device.

18. The method of claim 17, wherein more than one, but not all, of the set of variant passcodes is needed to form the complete passcode.

19. The method of claim 17, further comprising configuring an output device to indicate to the user that enrollment is complete.

20. The method of claim 17, wherein the passcode comprises a key for accessing encrypted data stored on the portable authentication device.
